(19) United States
(12) Patent Application Publication
(10) Pub. No.: US 2020/0300387 A1
(43) Pub. Date: Sep. 24, 2020

(54) Fluid Sampling Device

(71) Applicant: Alcoa of Australia Limited, Booragoon (AU)

(72) Inventors: Simon McCaskie, Booragoon (AU); Jake Richards, Booragoon (AU)

(21) Appl. No.: 16/893,260

(22) Filed: Jun. 4, 2020

Related U.S. Application Data
(63) Continuation of application No. PCT/AU2018/051306, filed on Dec. 5, 2018.

(30) Foreign Application Priority Data
Dec. 6, 2017 (AU) 2017904923

(51) Int. Cl. F16L 11/04; G01N 1/20

(52) U.S. Cl. CPC F16L 11/04; G01N 2001/1031; G01N 1/20

(57) ABSTRACT

A fluid sampling device for sampling fluids in a fluid process vessel through a port in a wall of the vessel, the sampling device comprising a flexible tube with an open end in fluid communication with the fluid process vessel, means to attach the sampling device to the process vessel, wherein at least a portion of the flexible tube is adapted to extend into the process vessel, wherein the length of the flexible tube extending into the process vessel is at least 5 times the outer diameter of the flexible tube.

### CROSS-REFERENCE TO RELATED APPLICATION

This application is a continuation application relating to and claiming the benefit of commonly-owned, co-pending International Patent Application No. PCT/AU2018/051306, filed Dec. 5, 2018, entitled “FLUID SAMPLING DEVICE”, which relates to and claims the benefit of commonly-owned Australia Patent Application No. 2017904923, filed Dec. 6, 2017, entitled “FLUID SAMPLING DEVICE,” the entireties of which are incorporated by reference herein.

### FIELD OF THE INVENTION

A fluid sampling device.

### BACKGROUND OF THE INVENTION

Tapping points are typically small bore (<1″ diameter) connections to process vessels that are used to extract samples from or to hydraulically couple on-line sensors to. They are used in many industrial processes. The relatively small bore of the connection, combined with process conditions favourable to precipitation, (brought about by, for example, high supersaturation, purge fluid addition or temperature variations), as can be found in many industries, make tapping points very susceptible to solid deposition, scale accumulation and eventual blockage. Tapping point blockages are a leading cause of online sensor and sample port failure and are a burden on both maintenance cost and safety management.

Tapping point blockages are presently remedied by clearing the associated isolation valve, for example by drilling. The remedy is often temporary as it provides a reduced bore and encourages rapid new solid deposition or scale growth. Tapping point isolation valve seizure is also a common failure and to avoid process interruption, the only remedy may be to install a new valve and tapping point online and possibly even another connected instrument—which requires specialist contractors with associated monetary and opportunity cost.

The preceding discussion of the background to the invention is intended to facilitate an understanding of the present invention. However, it should be appreciated that the discussion is not an acknowledgement or admission that any of the material referred to was part of the common general knowledge in Australia or any other country as at the priority date.

### SUMMARY OF INVENTION

In accordance with the present invention, there is provided a fluid sampling device for sampling fluids in a fluid process vessel through a port in a wall of the vessel, the sampling device comprising a flexible tube with an open end in fluid communication with the fluid process vessel, means to attach the sampling device to the process vessel, wherein at least a portion of the flexible tube is adapted to extend into the process vessel, wherein the length of the flexible tube extending into the process vessel is at least 5 times the outer diameter of the flexible tube wherein the portion of the flexible tube extending into the process vessel is substantially linear.

Advantageously, the flexing of the tube under fluid flow inhibits the build-up of scale or solid deposition on the flexible tube. In one form of the invention, the flexing of the tube facilitates dislodgement of any scale or solid that may have deposited on the tube.

Preferably, the flex of the tube causes the flexural strength of the scale or deposited solid to be exceeded.

Without being limited by theory, it is believed that the degree of flex required to exceed the flexural strength of the scale or deposited solid is not high. It is not intended that the flexibility of the tube is such that it undergoes significant departure from linearity when in use.

In the context of the present invention, the term fluid shall include any flow able material including slurries.

In the context of the present invention, the term vessel shall be understood to include any fluid receptacle including pipes and both open and closed reactors and other equipment.

In the context of the present specification, the term sampling shall be taken to include taking samples of a fluid for any purpose and shall also encompass in situ measuring of fluid properties.

In the context of the present specification, the term substantially inhibit scale or other solid build up shall be understood to include decreasing the rate of scale or other solid formation.

Preferably, the fluid sampling device comprises means to attach the sampling device to the process vessel.

The fluid sampling device may further comprise a valve to open or seal the port.

The flexible tube may be indirectly or directly in fluid communication with the valve. In one form of the invention, the flexible tube is directly connected to the valve. In a second form of the invention, there is provided a spacing element between the valve and the flexible tube. The spacing element may be provided in the form of a substantially rigid tube in fluid communication with the valve and in fluid communication with the flexible tube.

Advantageously, where the length of tube is at least 5 times greater than the outer diameter of the tube, the tube will be provided with a degree of flex. While the degree of flex of the tube will be affected by the properties of the material as well as the ratio of length to diameter, the inventors have identified that a ratio of at least 5 provides sufficient flex to substantially inhibit scale or other solid build up on the tube.

The fluid sampling device of the present invention may be used in a variety of industrial processes, including mineral processing, petrochemical, pulp and paper, steel making and oil refining. Within any industrial process, it may be used under a variety of conditions. It will be appreciated that fluids in industrial processes can range from fast flowing fluids to stagnant fluids.

It will be appreciated that different industries encounter different forms of scale or blockages. The skilled addressee in an industry will have knowledge of the typical types of scale or blockage encountered in any particular process vessel. Knowledge of typical types of scale or blockage will facilitate choices of appropriate tubes. In addition, information about the friability of potential scale or blockage material will inform the degree of flex required to inhibit scale or blockage formation.

For example, in the alumina industry, the most common forms of blockages are scales, including alumina (such as gibbsite and boehmite), aluminosilicates and other silicates and iron-based scale. The degree of scale or blockage in any process vessel will depend on fluid concentrations, temperatures, and flow rates among other properties.

Alternatively, the oil and gas industry encounters both inorganic and organic forms of blockages and scale, including alkaline earth carbonates and sulfates and wax.

Preferably, the flexible tube is polymeric.

The choice of polymer and the length of the tube requires consideration of the chemical properties of the fluid (e.g. pH, corrosiveness) and the mechanical properties of the fluid (e.g. temperature and flow rate) as well as the chemical properties of the polymer (resistance to corrosion), the mechanical properties of the polymer (flexibility and hardness) and the bore of the valve.

A first consideration may be the polymer's ability to resist or withstand the chemical properties of the fluid. Some processes into which a tube of the present invention may be immersed may limit the choice of material due to material compatibility. For example, silicone rubber would suffer attack in the alumina industry which utilises highly caustic fluids at high temperatures. Numerous industrial resources are available that provide information about the suitability of polymers in different process industries (e.g. www.plasticsintl.com/plastics chemical resistence chart: www.tss.trelleborg.com/en/resources/design-support-and-engineering-tools/chemical-compatibility; www.calpaclab.com/download-charts).

While factors such as fluid composition and temperature are relevant, as a general guide, the following polymers types may be suitable for the following environments.

TABLE 1
polymer types suitable in different industrial solutions.

| Industrial Solution | Polymer |
|---|---|
| Hydrochloric acid | LDPE, HDPE, TFE, PFA, FEP, ECTFE, ETFE, PS |
| Hydrogen Peroxide | HDPE, TFE, PFA, FEP, ECTFE, ETFE, PC |
| Kerosene | TFE, PFA, FEP, ECTFE, ETFE |
| Nitric Acid | TFE, PFA, FEP, ECTFE, ETFE |
| Petroleum | TFE, PFA, FEP, ECTFE, ETFE |
| Sodium Hydroxide | HDPE, PP, PPCO, PMP, TFE, PFA, |
| | FEP, ECTFE, ETFE |
| Sulfuric Acid | TFE, PFA, FEP, ECTFE, ETFE |
| Turpentine | TFE, PFA, FEP, ECTFE, ETFE |

LDPE: low density polyethylene;
HDPE: high density polyethylene;
TFE: tetrafluoroethylene;
PFA: perfluoroalkoxyl alkane;
FEP fluorinated ethylene propylene;
ECTFE: ethylene chlorotrifluoro ethylene copolymer;
ETFE: ethylene-tetrafluoroethylene;
PC polycarbonate;
PS: polystyrene

Silicone rubbers may be suited to water-based mining industries or waste water treatment. Silicone is a readily available, economical, and versatile material with good resistance to adhesion.

Fluoropolymers may be more suited to aggressive fluids such as those found in the mineral processing industries, (e.g. alumina (alkaline) and lithium carbonate (acidic)) and petroleum industries. Fluoropolymers generally have high levels of chemical and heat resistance, low permeability and low coefficient of friction. Exemplary fluoropolymers include perfluoroalkoxy (PFA), polytetrafluoroethylene (PTFE), fluorinated ethylene propylene (FEP), ethylene-tetrafluoroethylene (ETFE), polyvinyl fluoride, polyvinylidene fluoride, polytetrafluoroethylene, polychlorotrifluoroethylene, polyethylenetetrafluoroethylene and polyethylenechlorotrifluoroethylene.

Perfluoroalkoxy alkanes are copolymers of tetrafluoroethylene (C₂F₄) and perfluoroethers (C₂F₃OR¹, where R¹ is a perfluorinated group such as trifluoromethyl).

Preferably, the polymer has low permeability with respect to the components in the fluid to be sampled.

Preferably, the polymer has a low coefficient of friction. Most polymers have coefficients of friction in the range 0.2 to 0.6. Fluorocarbons generally have lower coefficients of friction hydrocarbon polymers. For example, fluorinated ethylene propylene, perfluoroalkoxyl alkane, ethylene tetrafluoroethylene, ethylene chlorofluoro ethylene copolymer all have extremely low coefficients of friction in the region of 0.14 to 0.25. Polytetrafluoroethylene has the lowest recorded m value for any material with a dynamic coefficient of friction of between 0.05 and 0.15 and a static coefficient of friction of approximately 0.05.

A further consideration is that if the polymer is too weak to survive the flexure either by elastic limit or by fatigue limit, then it may fail prematurely or be permanently deformed.

A further consideration is the inherent degree of flexibility of the polymer. Too much flexibility can cause a loss of shape and possible kinking of the tube. Too little flexibility might not permit shedding of adhered substances, as the tube may not deform sufficiently.

It is known to describe polymers by their flexural modulus. Flexural modulus is a property that is a measure of the tendency for a material to resist bending. The higher the flexural modulus, the lower the deflection under a given load. The preferred flexural modulus of a polymer will depend on many factors including flow velocities in the fluid process vessel. However, flexural moduli less than 10 GPa are preferred. In one form of the invention, the flexural modulus is less than 2.5 GPa. Flexural moduli of polycarbonates can be in the order of 2.5 GPa. Flexural moduli of PFA are in the order of 0.5 to 0.8 GPa.

It is known to describe polymers by their hardness. Hardness is defined as a materials resistance to permanent identification. Polymer hardness may be measure by Rockwell or Shore methods.

A further consideration is the adhesion resistance of the polymer. The tube or a coating thereof should display some inherent resistance to adhesion by the fouling materials present.

In one form of the invention, the polymer is a melt processed polymer. Without being limited by theory, it is believed that melt processed polymer have less micro cavities than other polymers, decreasing the propensity of build up of scale or other solids.

Liquors in the alumina industry are often highly caustic and extremely aggressive. PFA polymers demonstrate good compatibility with Bayer liquors and other properties beneficial to the invention.

The polymeric tube made be prepared by Additive Manufacturing. It will be appreciated that tubes prepared by additive manufacturing may exhibit different chemical and mechanical properties to tubes prepared by conventional techniques.

The choice of length and diameter of the tube will be influenced by the mechanical conditions of the fluid inside the process vessel. It is understood that the tube needs some degree of flex but not too much. The greater the fluid flow inside the process vessel, the shorter the tip may need to be for a given tube diameter. In process vessels with fast moving fluids, a longer tip (for example, greater than 300 mm) may be more prone to kinking or snapping (most likely at the internal wall of the process vessel). Alternatively, in a substantially static or slow-moving fluid, a longer tip can be used.

It will be appreciated that process vessels containing fast moving liquids may require a shorter tube than process vessels containing slower moving liquids.

Many industrial processes operate with a combination of fast moving fluids and low moving fluids. Fast moving fluids can be found in locations such as pipes, launders, heaters and digesters within any particular process. Slow moving fluids can be found in locations such as tanks.

Pipes with fluid under high pressure may have fluid velocities in the order of 10 s⁻¹. In the Bayer industry, fluids passing through a tight bend or a process designed to induce high shear may have fluid velocities in the order of 8 ms⁻¹. More generally, fluids in a pipe may flow at velocities in the order of 3-6 ms⁻¹ and slurries in a pipe often slower in the order of 2-5 ms⁻¹ and in pump suction lines in the order of 1 ms⁻¹. Fluids flowing at higher velocities often operate under turbulent flow. The flex of the tube will be influenced by the type of flow (turbulent or laminar) and can be estimated by the Reynolds number for a particular fluid and configuration.

It will be appreciated that near-wall fluid velocities may different from calculated or measured bulk velocities.

Lower flow regions can include thickener overflow launders with wall velocities up to 0.5 ms⁻¹ and precipitators with wall velocities in the order of 0.1-0.2 ms⁻¹.

In some industries, it is more common to describe fluid flow rates in terms of volume. With respect to the Bayer industry, a particular thickener overflow tank discharge spool can operate at flow rates up to 2600 kLhr⁻¹. Without being limited by theory, it is believed that a tube length of about 50-100 mm with an outer diameter of about 10 mm is appropriate. Alternatively, a particular thickener overflow weir may have a flow rate of 750 kLhr⁻¹. Without being limited by theory, it is believed that a tube length of about 150-200 mm with an outer diameter of about 10 mm is appropriate. Alternatively, in a precipitator vessel with relatively low flow rates, it is believed that a tube length of about 150-200 mm with an outer diameter of about 10 mm is appropriate.

The skilled addressee will recognise the propensity for any process vessel to block or scale. The chemical and physical properties of the fluid inside the vessel will have an effect on the degree of solid or scale build up. In addition to fluid velocity, key variables can include fluid turbulence (turbulent v laminar flow), particle loading, particle size and supersaturation. Particulate scaling (scaling resulting from particle deposition) is facilitated by high solids loading, fine particle size, low velocity relative to deposition surface and high supersaturation. Conversely crystallisation scaling is facilitated by low solids loading, small particle size, low velocity and low supersaturation.

High flowing fluids may result in less scaling than low flow or stagnant fluids. As an extreme example, stagnant liquors in the Bayer process can develop thick scale on internal vessel walls. In the Bayer process, this could be a surge vessel containing pregnant (green) liquor. In designing a fluid sampling device for such a process vessel, the length of the tube would need to extend past the level of scale or anticipated level of scale. The skilled addressee would understand what level of scale or solids build up would be expected to develop and at what rate in any process vessel within an industrial circuit.

In one form of the invention, the length of the flexible polymeric tube extending into the process vessel is between 5 and 100 times the outer diameter of the flexible polymeric tube. In an alternate form of the invention, the length of the flexible polymeric tube extending into the process vessel is between 5 and 50 times the outer diameter of the flexible polymeric tube. In an alternate form of the invention, the length of the flexible polymeric tube extending into the process vessel is between 5 and 40 times the outer diameter of the flexible polymeric tube. In an alternate form of the invention, the length of the flexible polymeric tube extending into the process vessel is between 5 and 30 times the outer diameter of the flexible polymeric tube. In an alternate form of the invention, the length of the flexible polymeric tube extending into the process vessel is between 5 and 20 times the outer diameter of the flexible polymeric tube. In an alternate form of the invention, the length of the flexible polymeric tube extending into the process vessel is between 5 and 10 times the outer diameter of the flexible polymeric tube.

In an alternate form of the invention, the length of the flexible polymeric tube extending into the process vessel is between 10 and 100 times the outer diameter of the flexible polymeric tube. In an alternate form of the invention, the length of the flexible polymeric tube extending into the process vessel is between 10 and 50 times the outer diameter of the flexible polymeric tube. In an alternate form of the invention, the length of the flexible polymeric tube extending into the process vessel is between 10 and 40 times the outer diameter of the flexible polymeric tube. In an alternate form of the invention, the length of the flexible polymeric tube extending into the process vessel is between 10 and 30 times the outer diameter of the flexible polymeric tube. In an alternate form of the invention, the length of the flexible polymeric tube extending into the process vessel is between 10 and 20 times the outer diameter of the flexible polymeric tube.

In an alternate form of the invention, the length of the flexible polymeric tube extending into the process vessel is between 20 and 100 times the outer diameter of the flexible polymeric tube. In an alternate form of the invention, the length of the flexible polymeric tube extending into the process vessel is between 20 and 50 times the outer diameter of the flexible polymeric tube. In an alternate form of the invention, the length of the flexible polymeric tube extending into the process vessel is between 20 and 40 times the outer diameter of the flexible polymeric tube. In an alternate form of the invention, the length of the flexible polymeric tube extending into the process vessel is between 20 and 30 times the outer diameter of the flexible polymeric tube.

In an alternate form of the invention, the length of the flexible polymeric tube extending into the process vessel is between 30 and 100 times the outer diameter of the flexible polymeric tube. In an alternate form of the invention, the length of the flexible polymeric tube extending into the process vessel is between 30 and 50 times the outer diameter of the flexible polymeric tube. In an alternate form of the invention, the length of the flexible polymeric tube extending into the process vessel is between 30 and 40 times the outer diameter of the flexible polymeric tube.

In an alternate form of the invention, the length of the flexible polymeric tube extending into the process vessel is between 40 and 100 times the outer diameter of the flexible polymeric tube. In an alternate form of the invention, the length of the flexible polymeric tube extending into the process vessel is between 40 and 50 times the outer diameter of the flexible polymeric tube.

In an alternate form of the invention, the length of the flexible polymeric tube extending into the process vessel is between 50 and 100 times the outer diameter of the flexible polymeric tube.

In form of the invention, the length of the flexible polymeric tube extending into the process vessel is about 5 times the outer diameter of the flexible polymeric tube. In an alternate form of the invention, the length of the flexible polymeric tube extending into the process vessel is about 10 times the outer diameter of the flexible polymeric tube. In an alternate form of the invention, the length of the flexible polymeric tube extending into the process vessel is about 20 times the outer diameter of the flexible polymeric tube. In an alternate form of the invention, the length of the flexible polymeric tube extending into the process vessel is about 30 times the outer diameter of the flexible polymeric tube. In an alternate form of the invention, the length of the flexible polymeric tube extending into the process vessel is about 40 times the outer diameter of the flexible polymeric tube. In an alternate form of the invention, the length of the flexible polymeric tube extending into the process vessel is about 50 times the outer diameter of the flexible polymeric tube. In an alternate form of the invention, the length of the flexible polymeric tube extending into the process vessel is about 100 times the outer diameter of the flexible polymeric tube.

In one form of the invention, the length of the flexible polymeric tube extending into the process vessel is between 50 mm and 1000 mm. In an alternate form of the invention, the length of the flexible polymeric tube extending into the process vessel is between 50 mm and 500 mm. In an alternate form of the invention, the length of the flexible polymeric tube extending into the process vessel is between 50 mm to 400 mm. In an alternate form of the invention, the length of the flexible polymeric tube extending into the process vessel is between 50 mm to 300 mm. In an alternate form of the invention, the length of the flexible polymeric tube extending into the process vessel is between 50 mm to 200 mm. In an alternate form of the invention, the length of the flexible polymeric tube extending into the process vessel is between 50 mm to 100 mm.

In one form of the invention, the length of the flexible polymeric tube extending into the process vessel is between 100 mm and 1000 mm. In an alternate form of the invention, the length of the flexible polymeric tube extending into the process vessel is between 100 mm and 500 mm. In an alternate form of the invention, the length of the flexible polymeric tube extending into the process vessel is between 100 mm to 400 mm. In an alternate form of the invention, the length of the flexible polymeric tube extending into the process vessel is between 100 mm to 300 mm. In an alternate form of the invention, the length of the flexible polymeric tube extending into the process vessel is between 100 mm to 200 mm.

In one form of the invention, the length of the flexible polymeric tube extending into the process vessel is between 200 mm and 1000 mm. In an alternate form of the invention, the length of the flexible polymeric tube extending into the process vessel is between 200 mm and 500 mm. In an alternate form of the invention, the length of the flexible polymeric tube extending into the process vessel is between 200 mm to 400 mm. In an alternate form of the invention, the length of the flexible polymeric tube extending into the process vessel is between 200 mm to 300 mm.

In one form of the invention, the length of the flexible polymeric tube extending into the process vessel is between 300 mm and 1000 mm. In an alternate form of the invention, the length of the flexible polymeric tube extending into the process vessel is between 300 mm and 500 mm. In an alternate form of the invention, the length of the flexible polymeric tube extending into the process vessel is between 300 mm to 400 mm.

In one form of the invention, the length of the flexible polymeric tube extending into the process vessel is between 400 mm and 1000 mm. In an alternate form of the invention, the length of the flexible polymeric tube extending into the process vessel is between 400 mm and 500 mm.

In one form of the invention, the length of the flexible polymeric tube extending into the process vessel is about 25 mm. In an alternate form of the invention, the length of the flexible polymeric tube extending into the process vessel is about 50 mm. In an alternate form of the invention, the length of the flexible polymeric tube extending into the process vessel is about 75 mm. In an alternate form of the invention, the length of the flexible polymeric tube extending into the process vessel is about 100 mm. In an alternate form of the invention, the length of the flexible polymeric tube extending into the process vessel is about 150 mm. In an alternate form of the invention, the length of the flexible polymeric tube extending into the process vessel is about 200 mm. In an alternate form of the invention, the length of the flexible polymeric tube extending into the process vessel is about 300 mm. In an alternate form of the invention, the length of the flexible polymeric tube extending into the process vessel is about 400 mm. In an alternate form of the invention, the length of the flexible polymeric tube extending into the process vessel is about 500 mm. In an alternate form of the invention, the length of the flexible polymeric tube extending into the process vessel is about 1000 mm.

The internal diameter of the flexible hose is preferably between 5 mm and 50 mm. More preferably, the internal diameter is between 5 mm and 20 mm. In one form of the invention, the internal diameter of the tube is about 10 mm. In an alternate form of the invention, the internal diameter of the tube is about 8 mm.

The outside diameter of the flexible hose is preferably between 5 mm and 50 mm. More preferably, the outer diameter is between 5 mm and 20 mm. In one form of the invention, the outer diameter of the tube is about 10 mm.

The wall thickness of the flexible hose is preferably between 1 mm and 5 mm. More preferably, the internal diameter is between 1 mm and 2 mm. In one form of the invention, the internal diameter of the tube is about 1 mm.

It will be appreciated that different ports can serve a different purpose depending on the type of processing to be undertaken. For example, tube ports can be coupled with a fluid line for dispensing fluids or other components into a vessel or for removing samples therefrom. Where samples are removed, the fluid sample may be analysed remotely or in situ. In addition, tubes ports can be used to provide on-line measurement-probes such as pressure, temperature, pH, conductivity or flow.

The tube may be installed fully through an isolating ball valve. The ball valve is then rendered inoperative for convenient isolation, but is able to be preserved for emergency isolation—with little effort the liner tube can be sheared off by operating the valve. In this case, a jig/tool is available that can safely clear the old liner and extrude a new liner into the tapping point while the process remains online. The old liner remnants are pushed into the process where they are easily destroyed by pumps or settle in tank bottoms.

The tube may be held in place by specially made nipples on either side of a conventional full-bore ball valve (isolation valve). The liner is commonly available chemical tubing (e.g. Swagelok PFA-T8-063 ½″ hose).

### BRIEF DESCRIPTION OF THE DRAWINGS

Further features of the present invention are more fully described in the following description of a non-limiting embodiment thereof. This description is included solely for the purposes of exemplifying the present invention. It should not be understood as a restriction on the broad summary, disclosure or description of the invention as set out above. The description will be made with reference to the accompanying drawing in which:

FIG. 1 is a cross sectional view of a fluid sampling device in accordance with an embodiment of the invention.

### DESCRIPTION OF EMBODIMENTS

Throughout the specification, unless the context requires otherwise, the word “solution” or variations such as “solutions”, will be understood to encompass slurries, suspensions and other mixtures containing undissolved solids.

Throughout this specification, unless the context requires otherwise, the word “comprise” or variations such as “comprises” or “comprising”, will be understood to imply the inclusion of a stated integer or group of integers but not the exclusion of any other integer or group of integers.

Those skilled in the art will appreciate that the invention described herein is amenable to variations and modifications other than those specifically described. It is to be understood that the invention includes all such variations and modifications. The invention also includes all of the steps, features, compositions and compounds referred to or indicated in the specification, individually or collectively and any and all combinations or any two or more steps or features.

It is known to use tapping points in many industrial settings. Routine maintenance is required on them. In the Bayer process, areas more prone to rapid scaling are those in the green liquor part of the circuit from digestion through to heat exchange and washers (such as post digestion clarifier underflows, thickener and washer underflows and overflows, security filtration and green liquor storage.) and require frequent drilling and exercising of ball valves to prevent any significant failures. Scale can grow rapidly inside the valve, resulting in blockages or seizures, which can cause undesirable process disruptions.

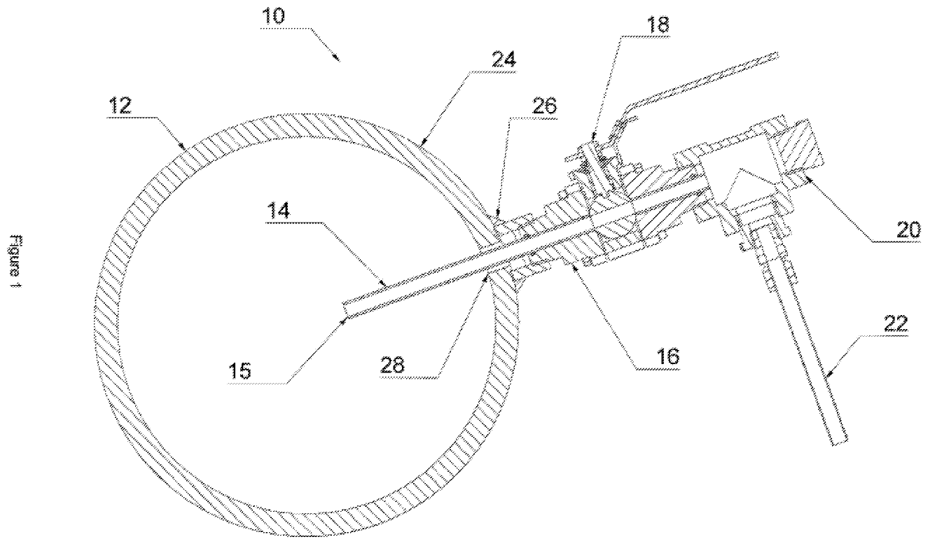

In FIG. 1, there is shown a cross-sectional view of an embodiment of a fluid sampling device, depicted as a tapping point assembly 10 attached to a process vessel 12. The tapping point assembly 10 comprises a flexible PFA tip 14, with an open end 15, an adaptor 16 to retain a portion of the tip, an isolating ball valve 18, fittings 20 as required depending on the application and a tube 22 as required connected to equipment.

The tapping point assembly 10 is attached to the boundary surface 24 of the process vessel 12. In the embodiment of FIG. 1 a body 26 of the tapping point assembly 10 is welded to a port 28 in the boundary surface 24. The body 26 comprises preferably an annular shaped base, the welded joint being between the peripheral surface of this base portion and the edge of the port.

In use, fluid from the process vessel 12 enters the tapping point assembly 10 through the open end 15 of the flexible tip 14. The flexible tip 14 is not permeable to the fluid.

Flexible PFA tubes in accordance with the present invention have been installed at locations throughout a Bayer circuit.

Four tubes were installed on tapping points in a thickener overflow launder tank (medium fluid velocity) and remained substantially scale free for the time frames shown below, comparing favourably to standard tapping points which generally require cleaning after 40-50 days.

TABLE 2
Tube performance.

| Tube length (mm) | Length:Diameter Ratio | Days without blockage |
|---|---|---|
| 100 | 7 | 394 |
| 200 | 15 | 322 |
| 300 | 23 | 72* |
| 400 | 30 | 395 |

*Failure not related to PFA tip scaling. The tank under trial went offline for overhaul.

Three tubes were installed on tapping points in a D tank (high fluid velocity) as shown below in Table 3.

TABLE 3
Tube performance.

| | Tube | Length:Diameter | Days without |
|---|---|---|---|
| Location | length (mm) | Ratio | blockage |
| Level Gauge | 75 | 5 | 156¹ |
| Clarity Meter | 75 | 5 | 296² |
| Liquor Analyser | 75 | 5 | 296² |

¹one maintenance activity required
²three maintenance activities required

Four tubes were installed on tapping points in a D tank (high velocity) as shown below in Table 4.

TABLE 4
Tube performance.

| | Tube | Length:Diameter | Days without |
|---|---|---|---|
| Location | length (mm) | Ratio | blockage |
| Level Gauge | 100 | 7 | 105 |
| Liquor Analyser | 100 | 7 | 92¹ |
| Level Gauge | 100 | 7 | 92 |
| Liquor Analyser | 100 | 7 | 92 |

¹one maintenance activity required

A D-tank is to be understood as a tank between a thickener overflow and security filtration. In a typical Bayer circuit, liquor may have a residence time of 0.5 hr to about 2 hr.

Standard tapping points installed in similar environments had a maximum lifespan of 24-35 days.

A further tube was installed on a thickener underflow with a 100mm protrusion as shown below in Table 5.

TABLE 5:
Tube performance.

| Tube length (mm) | Length:Diameter Ratio | Days without blockage |
|---|---|---|
| 100 | 7 | 56 |

Standard tapping point installed in similar environments had a maximum lifespan of about 14 days.

It is known to use/install probes in industrial circuits for regular analysis of fluid properties. Such probes remain in the liquid and depending on the conditions, can be prone to scaling. One application is the use of clarity meter probes on thickener overflow launders. Sampling probes of scale resistant materials or with scale resistant coatings have been tested by the applicant. The applicant's experience that such and sample probe tips do scale over time.

It is known to use metallic or other rigid probes, tubes or lances that extend into vessels. Such probes can extend by up to 2 m into a vessel. To reduce scaling, stainless steel tips (½″ diameter) were tipped with PFA which extended out the end of the probe into the vessel by 50 mm to 200 mm. The results showed that all tips of different lengths behaved similarly with significantly reduced rates of scaling. In addition to reducing scaling rates, any scale was simple to remove by distorting (e.g. squeezing) the tip.

What is claimed is:

1. A fluid sampling device for sampling fluids in a fluid process vessel through a port in a wall of the vessel, the sampling device comprising a flexible tube with an open end in fluid communication with the fluid process vessel, means to attach the sampling device to the process vessel, wherein at least a portion of the flexible tube is adapted to extend into the process vessel, wherein the length of the flexible tube extending into the process vessel is at least 5 times the outer diameter of the flexible tube, wherein the portion of the flexible tube extending into the process vessel is substantially linear.

2. A fluid sampling device in accordance with claim 1, wherein the portion of the flexible tube extending into the process vessel is substantially linear when in use.

3. A fluid sampling device in accordance with claim 1, wherein the fluid sampling device comprises means to attach the sampling device to the process vessel.

4. A fluid sampling device in accordance with claim 1, wherein the fluid sampling device comprises a valve to open or seal a port in the process vessel.

5. A fluid sampling device in accordance with claim 1, wherein the flexible tube is indirectly or directly in fluid communication with the valve.

6. A fluid sampling device in accordance with claim 5, wherein the fluid sampling device comprises a spacing element between the valve and the flexible tube.

7. A fluid sampling device in accordance with claim 6, wherein the spacing element is a substantially rigid tube in fluid communication with the valve and in fluid communication with the flexible tube.

8. A fluid sampling device in accordance with claim 1, wherein the flexible tube is polymeric.

9. A fluid sampling device in accordance with claim 8, wherein the polymer has high chemical resistance and high heat resistance.

10. A fluid sampling device in accordance with claim 8, wherein the polymer has low permeability.

11. A fluid sampling device in accordance with claim 8, wherein the polymer has a low coefficient of friction.

12. A fluid sampling device in accordance with claim 8, wherein the polymer is a fluoropolymer.

13. A fluid sampling device in accordance with claim 12, wherein the fluoropolymer is selected from the group comprising perfluoroalkoxy (PFA), polytetrafluoroethylene (PTFE), fluorinated ethylene propylene (FEP), ethylene-tetrafluoroethylene (ETFE), polyvinyl fluoride, polyvinylidene fluoride, polytetrafluoroethylene, polychlorotrifluoroethylene, polyethylenetetrafluoroethylene and polyethylenechlorotrifluoroethylene.

14. A fluid sampling device in accordance with claim 1, wherein the length of the flexible tube extending into the process vessel is between 5 and 100 times the outer diameter of the flexible tube.

15. A fluid sampling device in accordance with claim 1, wherein, the length of the flexible tube extending into the process vessel is between 50 mm and 1000 mm.

16. A fluid sampling device in accordance with claim 1, wherein, the internal diameter of the flexible tube is 5 mm and 50 mm.

17. A fluid sampling device in accordance with claim 1, wherein, the wall thickness of the flexible hose is between 1 mm and 5 mm.
